(19) United States
(12) Patent Application Publication
(10) Pub. No.: US 2003/0022141 A1
(43) Pub. Date: Jan. 30, 2003

(54) Interactive patient educational tool

(76) Inventor: R. Andrew Packard, Huntington, NY (US)

Correspondence Address: Rocco S. Barrese, Esq., DILWORTH & BARRESE, LLP, 333 Earle Ovington Blvd., Uniondale, NY, 11553, US

(21) Appl. No.: 10/116,876

(22) Filed: Apr. 5, 2002

Related U.S. Application Data
(63) Continuation of application No. PCT/US00/27421, filed on Oct. 5, 2000.
(60) Provisional application No. 60/157,817, filed on Oct. 5, 1999.

(51) Int. Cl. G09B 23/28

(52) U.S. Cl. 434/262

(57) ABSTRACT

A method and system for educating patients and consumers in medical and health information, is presented. In the preferred embodiments, the system and method presents an interactive presentation of medical and health information to a subject, tests the subject in the presented medical and health information, provides Health Maintenance Organizations (HMOs) and health insurance companies with relevant statistics and information concerning individual patients and patient groups, and provides doctors with feedback concerning patient's knowledge and understanding of the medical and health information.

### BACKGROUND OF THE INVENTION

1. Field of the Invention

The present invention relates generally to methods and systems of educating patients and consumers in medical and health information, providing Health Maintenance Organizations (HMOs) and health insurance companies with relevant statistics and information concerning individual patients and patient groups, and providing doctors with feedback concerning a patient's knowledge and understanding of the medical and health information.

2. Description of the Related Art

In the health care industry, the education of the patient has become increasingly important, while the ability to provide that education has decreased. The simple fact is that patients need more information about their conditions and/or diseases than they are currently receiving from their overburdened doctors. Patients cannot take more responsibility for their health care unless they know enough relevant information about causes, symptoms, avoidance techniques, medications, etc. On the other side, in the current healthcare industry, doctors' fees have been dramatically reduced by HMOs, and the only way doctors can survive financially is to escalate the number of patients they see on a daily basis, i.e., to make up in volume for their substantially diminished operating margins. Overwhelmed doctors thus may no longer have the time to educate patients about their conditions and/or diseases, even though they recognize that such education would benefit their patients and lead to healthier lives, diminish the use of emergency medical treatment, and lower costs to the entire medical system. HMOs are struggling with escalating cost structures that threaten their own viability.

Until now, the medical community has been unable to provide effective, systematic methods to educate patients and consumers in preventive health care and well care. Overburdened physicians and nurses have of necessity focused on diagnosis and treatment of immediate medical issues, and have not had the luxury of time to adequately educate patients about all aspects of their medical problems. The economics of medicine as practiced today simply does not afford physicians adequate time for thorough patient education. At the same time, physicians (and hospitals) are now receiving “report cards” from HMOs, insurance companies and accrediting organizations on the quality of their patient education.

HMOs have every incentive to promote patient education, since numerous studies and articles have demonstrated substantial cost savings for each dollar spent on education, typically a 4-to-1 return on investment. HMOs have responded by aggressively pushing patient education. They exhort (and threaten) doctors to allocate time for it—and the doctors generally respond that they simply cannot allocate more time. The HMOs currently spend substantial sums on patient education, but by and large, the spending—on print literature, advertising, and videos—is ineffective at best. The HMOs simply do not have the close connection with patients that doctors have.

The truth is that effective, comprehensive education of patients and consumers with documented results does not currently exist. Therefore, a need exists for meaningful education which utilizes professional skilled personnel who interact with patients and consumers using modern computer technology to truly educate, and effectively change patient behavior. A need also exists for a system and method that interactively educates patients under the guidance of medical personnel, which satisfies the insurer's need for statistical and educational compliance information, and also satisfies the primary care physician's need for feedback regarding an individual patient's knowledge base.

### SUMMARY OF THE INVENTION

It is an object of the present invention to provide a system and method for interactively educating patients under the guidance of medical personnel as well as consumers generally, for providing the patient's insurer with statistical and educational compliance information, and for providing the patient's physician with feedback concerning an individual patient's knowledge base.

It is also an object of the present invention to increase the efficiency of patient care by having an entity other than the doctor educating patients, thereby increasing the physician's care-taking time, and ensuring that the patients know and understand certain medical conditions, treatments, and medications.

It is also an object of the present invention to involve patients and consumers in the responsibility for their own care, by providing them with the tools and skills to teach themselves concerning different medical topics, such as smoking cessation and weight loss, and aiding them in changing their behavior.

It is also an object of the present invention to promote healthy lifestyles through educating patients and consumers in an environment conducive to learning. This environment includes not only the presentation format of the educational materials, but also the physical architecture of a learning center and any factor that may assist in the educational experience.

It is yet another object of the present invention to significantly reduce medical costs by reducing physician's time spent educating patients, and by reducing the long-term care costs of individual patients through behavior modification.

In order to fulfill these and other objects, the present invention provides a system and method for a truly interactive, integrated computer-based system of education of patients and consumers. In one preferred embodiment, the system is integrated with a complete course of treatment for a patient—both the primary care physician and the insurer are provided with feedback from the patient, as well as having the ability to provide input to effectively change patient behavior.

At the center of this preferred embodiment of the system and method is a Patient Teaching Module™ (PTM), a stand-alone computer software program linked to a central computer system, the doctor's office, and the insurer. The modules are comprehensive, turnkey systems providing multimedia education of patients and consumers for a variety of medical conditions and diseases, with particular emphasis on those medical conditions that lend themselves to remediation or improvement with active patient participation. In other embodiments, the software program does not link with a central computer system, nor with the physician's office, nor with the insurer.

### BRIEF DESCRIPTION OF THE DRAWINGS

FIG. 1 is a schematic block diagram of the links between the patient, the patient's physician, and the patient's insurer;

FIG. 2 is the schematic block diagram of FIG. 1 showing the intermediary location filled by an embodiment of the present invention;

FIG. 3 is a diagram of the steps performed by a patient according to a preferred embodiment of the present invention;

FIG. 4 is a diagram showing different ways a patient may take a Patient Teaching Module according to various embodiments of the present invention;

FIG. 5 is a flowchart of the steps performed in FIG. 3, according to a preferred embodiment of the present invention;

FIG. 6 is a diagram of an embodiment directed towards educating students, according to the present invention;

FIG. 7 is flowchart of the standby looping of a Patient Training Module, according to a preferred embodiment of the present invention;

FIG. 8 is a flowchart of the beginning sequence of a Patient Training Module, according to a preferred embodiment of the present invention;

FIG. 8A is an exemplary screen display from a Patient Teaching Module, according to a preferred embodiment of the present invention;

FIG. 8B is a detailed flowchart of the sequence of sections in a Patient Training Module, according to a preferred embodiment of the present invention; and

FIGS. 8C and 8D are exemplary screen displays used in a Patient Training Module, according to a preferred embodiment of the present invention.

### DETAILED DESCRIPTION OF THE PREFERRED EMBODIMENTS

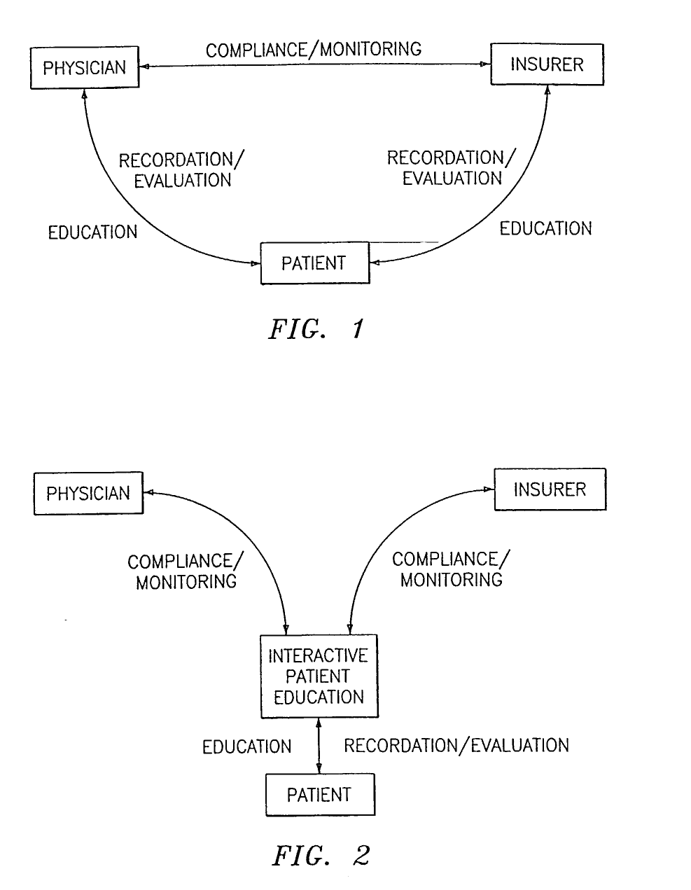

In its most broad aspect, the preferred embodiments of the present invention provide a system and method for sharing information amongst and between the patient, the patient's physician, and the patient's insurer. As shown in FIG. 1, the first form of information sharing is the education of the patient in certain medical topics relevant to that patient's condition and/or medication. Presently, as shown in FIG. 1, this is performed by the patient's physician and/or the patient's insurer. However, both means of education are increasingly ineffective and inefficient. The second type of information sharing is the recordation and evaluation of the patient's understanding of the medical topic. Presently, as shown in FIG. 1, this is performed (or not) by the patient's physician and/or the patient's insurer. This can be done on an individual and a group-wide basis. The third type of information sharing is between the physician and the insurer—as discussed above, this may take the form of “report cards” and may be used to monitor the physician's educational compliance.

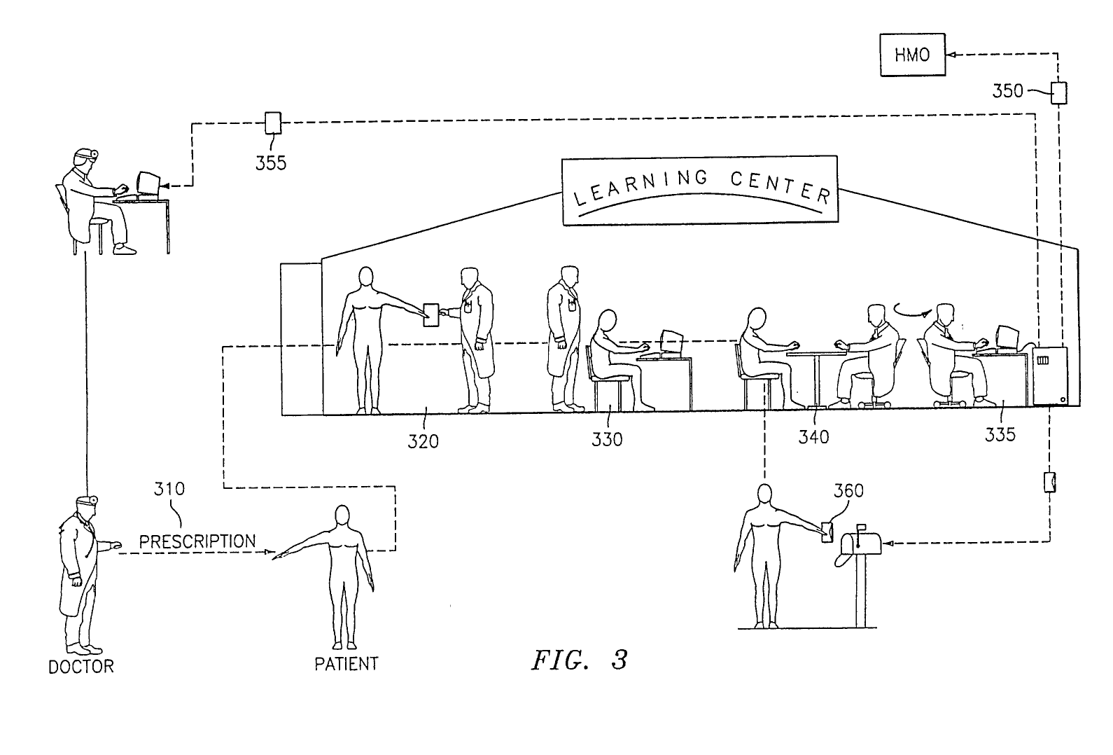

The preferred embodiments of the present invention act as an intermediary in these relationships, as shows in FIG. 2. The preferred embodiments of the present invention takes on a role alongside and between the patient, the physician, and the insurer—teaching the patient regarding medical topics, informing the physician on the strengths and weaknesses of the patient's knowledge and compliance, and informing the insurer about compliance and general trends in patient knowledge.

In the preferred embodiment, the location of the educational process is a Learning Center, where the patient interacts with Patient Teaching Modules™ (PTMs), which will be described in greater detail below. However, the Learning Center is not necessary to the present invention, for the patient or consumer could interact with the PTM at a terminal in the physician's office, a hospital, workplace, school, or at home at a computer linked through the Internet.

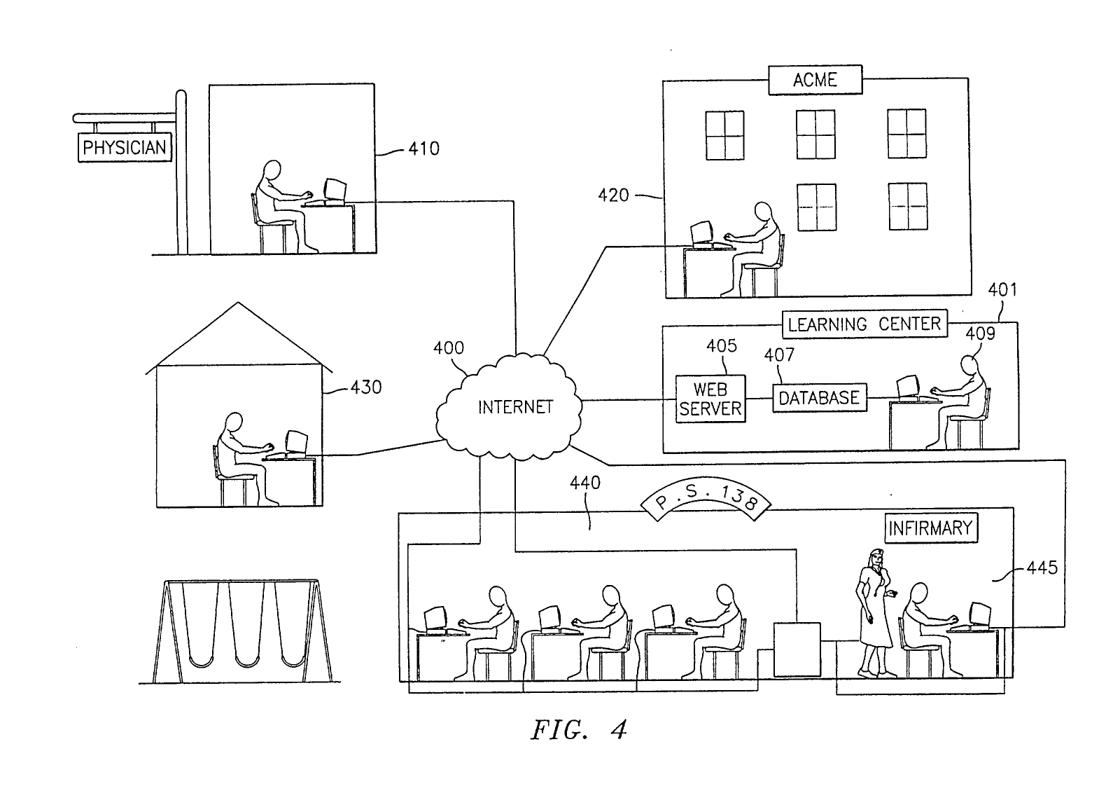

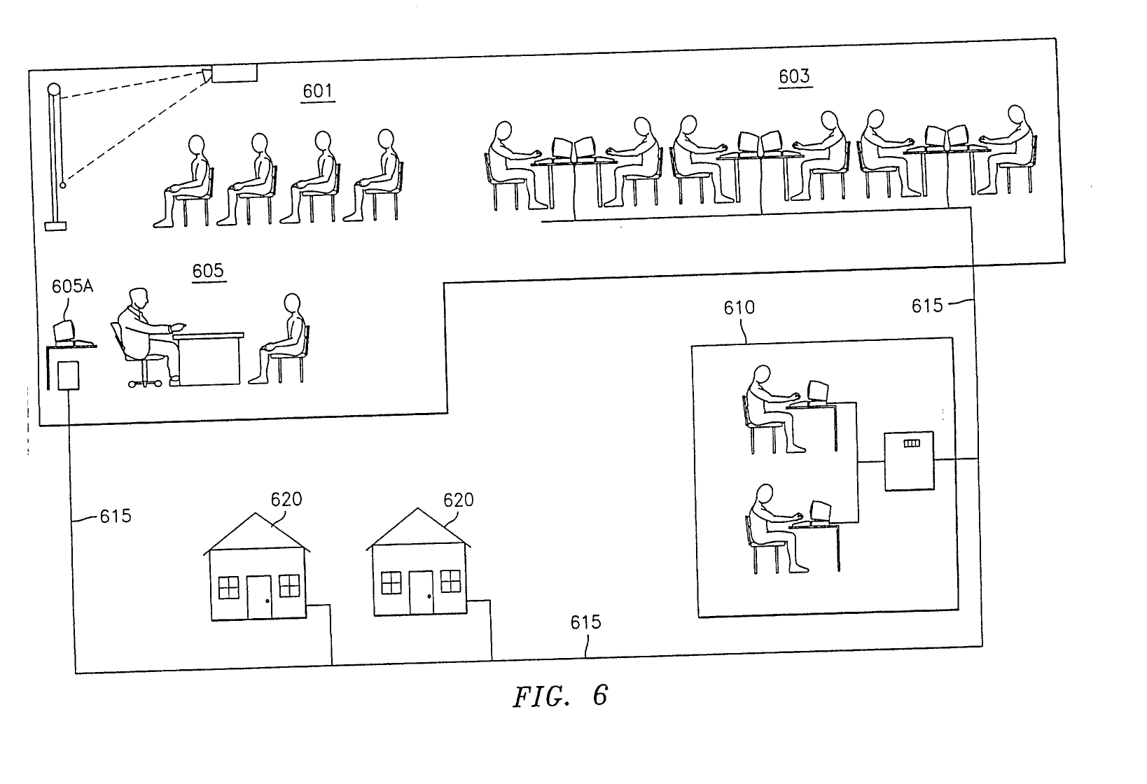

In one preferred embodiment, of which the steps are described in FIG. 5 and illustrated in FIG. 3, the physician issues a ‘prescription’ (310) to a patient that ‘prescribes’ a particular PTM (step 510). Both the Learning Center and the insurer are informed of the prescription (step 520) and, when the patient arrives at the Learning Center (320 and step 530), he or she is guided to a console to take the appropriate PTM (330 and step 540). The patient answers questions that are recorded and evaluated by Learning Center personnel (335 and steps 550 and 560). In this embodiment, Learning Center personnel perform an exit interview (340) to review the material with the patient. The Learning Center personnel ensure that the physician is informed of the results (355 and step 573), and that the insurer is informed of the patient's compliance (350 and step 575). The Learning Center personnel may also provide follow-ups and reminders (360 and step 580), as indicated by the patient's results, or perhaps by the physician and/or the insurer.

Of course, in other embodiments, a ‘prescription’ may not be necessary for a PTM, and a patient or consumer could ‘walk-in’ to a Learning Center to take different PTMs that the insurer may offer, or a patient or consumer may take a PTM over the Internet. Likewise, a home consumer could obtain a CD-ROM that contains the PTM. The information given to the physician and the insurer concerning the patient's test results might be analyzed by computer and communicated by electronic means, without the aid of human personnel.

Below, the various parts of the system and method will be discussed in detail: The Learning Center; The Patient Teaching Modules; and Feedback, Follow-up, and Analysis.

A. The Learning Center

In the preferred embodiment, the Learning Center is designed with the aid of neuropsychologists to insure the most productive and pleasant educational experience for the patient. For instance, since many patients, particularly older ones, are computer-phobic, the center is preferably designed so that patients do not have to cope with computers or keyboards. The Learning Center can be freestanding, or located in a doctor's or dentist's office, or in a hospital, clinic or school. Patients preferably utilize touch screens in semi-private enclosures and, except for the touchscreen, the ‘guts’ of the computer are not in plain sight. Further, the patient may use headphones while using the learning module to enhance privacy. The interior architecture is designed to enhance the feeling of privacy and comfort: a spoke and hub design may be used for the consoles, and a separate waiting room may be used to welcome the patient in and provide a transition to the class room.

For a substantial portion of patients, technology alone is insufficient to educate. Thus, in a preferred embodiment of the invention, a nurse or nurse practitioner is an essential component of the learning experience at the Learning Center. The nurse or nurse practitioner, with the help of an educational assistant, assists the patient throughout the patient's time at the learning center, including initial orientation, entry of biographical data, assistance with the computer and the learning module, questions of any kind and, perhaps most importantly, subsequent follow up with both the patient and the physician. In the preferred embodiment, the nurse practitioner or the educational assistant enters the patient's biographical information using wired or remote keyboards, or ‘swipe’ cards, and then the patient enters certain demographic data by simply touching relevant choices on the screen. After the patient has completed the PTM, the nurse practitioners analyze the results, recognize deficiencies, and conduct an exit interview with the patient. The nurse practitioner's analysis and annotations are then communicated to the physician, preferably over a network or the Internet. The nurse practitioners also conduct regular, personalized follow-ups, as will be discussed below, with the aim of engendering patient comfort, confidence and compliance.

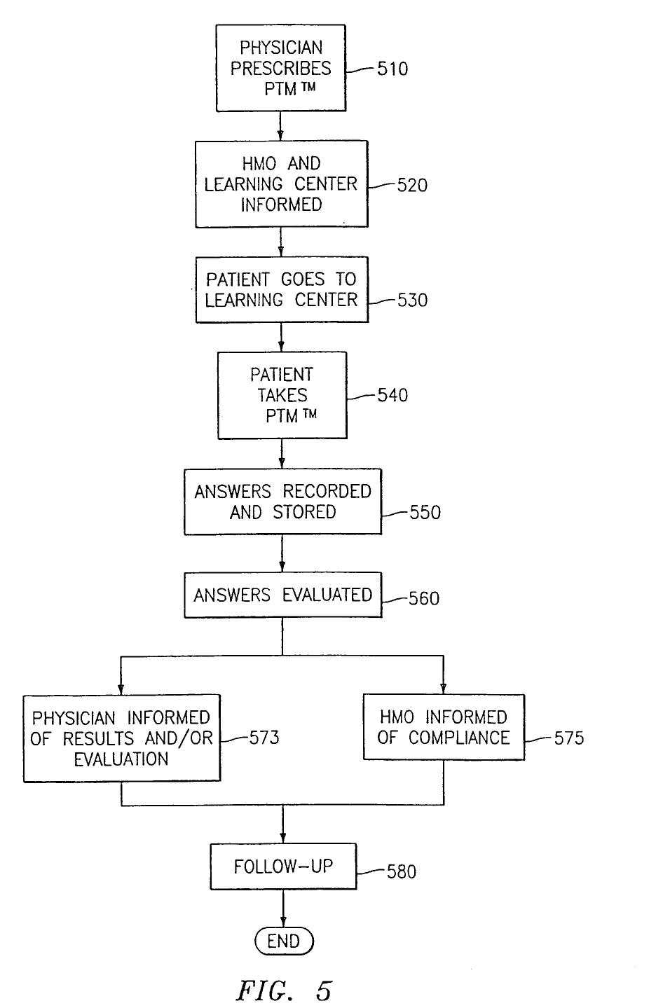

As noted above, although using the Learning Center as the location for taking the PTM is the preferred embodiment, other locations may be used for taking a PTM, including the physician's office, or on a computer in the consumer's home, school, or place of employment. In one embodiment, the Learning Center is inside a hospital, and is integrated into the course of treatment performed there. This is shown in the embodiment of FIG. 4, where the Learing Center 401 is equipped with a Web Server 405, a Database 407, and at least one terminal staffed by medical personnel 409. The Web Server 405 is connected to the Internet 400, and provides the PTMs to patients over the Internet 400 as well as enabling storage of answers, results, prescription information, and patient information in Database 407. Patients take the appropriate PTMs by logging in from the physician's office 410, the workplace 420, or the home 430. It should be noted that, although FIG. 4 shows the Internet 400 as the communication means, other means are used in other embodiments. For instance, a direct wire connection could be maintained between the Learning Center 401 and physicians' offices, clinics, hospitals, etc. At the other end of the spectrum is an embodiment where the PTM is embodied in an interactive CD-ROM, and the patient writes the answers on pre-formatted forms that are sent to the Learning Center 401, where they are analyzed and the physician and HMO are informed.

In the bottom of FIG. 4, a school is connected through the Internet 400 to the Learning Center 401. In one part of the school 440, students are taking one or more PTMs en masse in a computer lab. In another part of the school, namely, the infirmary 445, the school nurse directs a student to take a particular PTM. In this case, the school nurse prescribes PTMs which individual students may take in a private setting.

In all embodiments, although the nurses or nurse practitioners are preferred as medical personnel 409, their analytic and follow-up functions may be carried out by other medical personnel or by computer means.

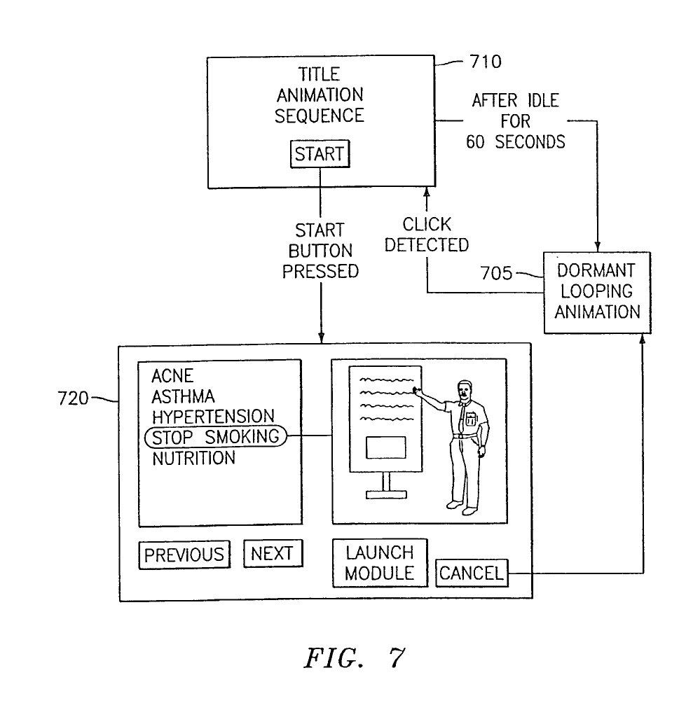

FIG. 6 further elucidates the form a school embodiment such as 440 in FIG. 4 may take. PTM's on various educational topics, including, but not limited to, tobacco prevention, tobacco cessation, pediatric asthma and nutrition, are administered to a class 601 in a school 600. The class then answers the questions on terminals 603. The test results are transmitted electronically over network 615 to Learning Center 610, where trained medical personnel analyze the test data. Their analysis, and, perhaps, the test results are communicated over network 615 to parents at home 620 and/or to school administrators 605. Network 615 could be a private network, the Internet, peer-to-peer connections, etc. School administrators may use the information to counsel children or parents, as well as make detailed curricula based on computer analysis 605A of what is seen as weaknesses or strengths of the entire student body's health knowledge. In this embodiment, students are encouraged to follow-up the PTM with visits to a website maintained by the Learning Center 610. Besides additional information, there would be chat rooms and other devices to induce students to remain involved in their health education.

As mentioned above, in other embodiments, individual consumers searching the Internet for relevant medical information can purchase an appropriate PTM that can be downloaded directly or sent to them on a CD-ROM. The test results are electronically transmitted to medical personnel who analyze the test data and communicate results to the consumer with or without further follow up.

B. The Patient Teaching Module

At the heart of the preferred embodiments of the present invention is the Patient Teaching Module. Content for each PTM is developed under the supervision of a team of experts, including medical professionals and educators to ensure clarity, simplicity and effective education. Modules are designed to be entertaining, interactive programs that not only educate, but prove education through tested, hard copy results. The subject matter in any PTM is initially constructed by a noted physician in his or her field, with a view towards establishing the most comprehensive learning experience for the particular disease or condition. The draft of the learning module is then reviewed by medical and educator panels to conform to the standards for ensuring effective education in that field. The questions are designed with the aid of neuropsychologists and educators to ensure understanding of the material presented and to promote compliance with the desired objectives. In the preferred embodiment, the PTMs are implemented by means of computers, although any audio-visual or other presentation means could be used for the educational section, and ordinary paper tests could be used for the testing section.

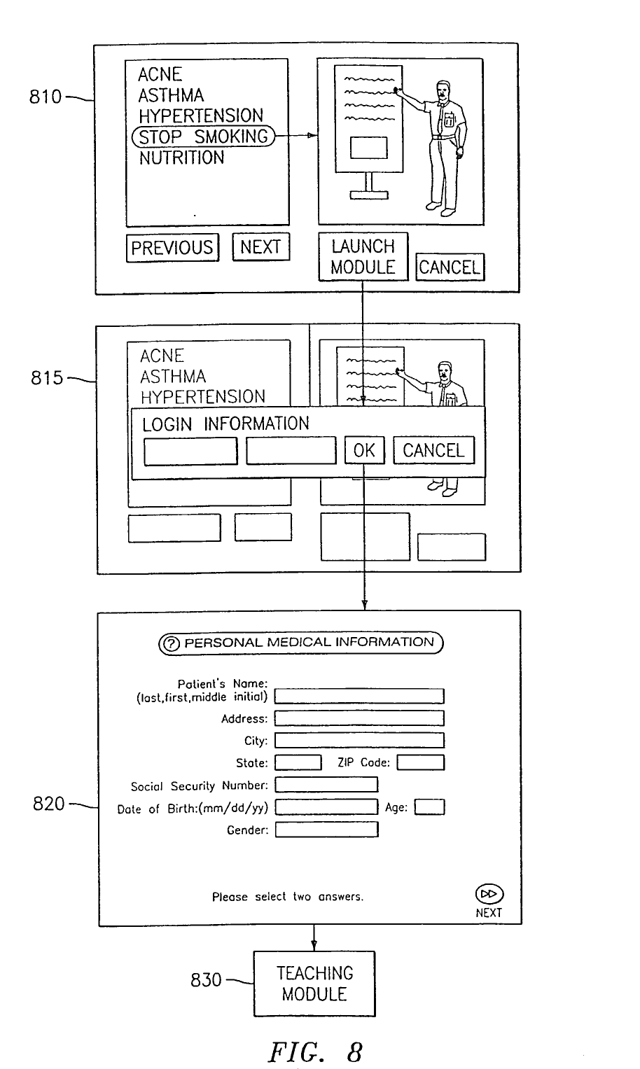

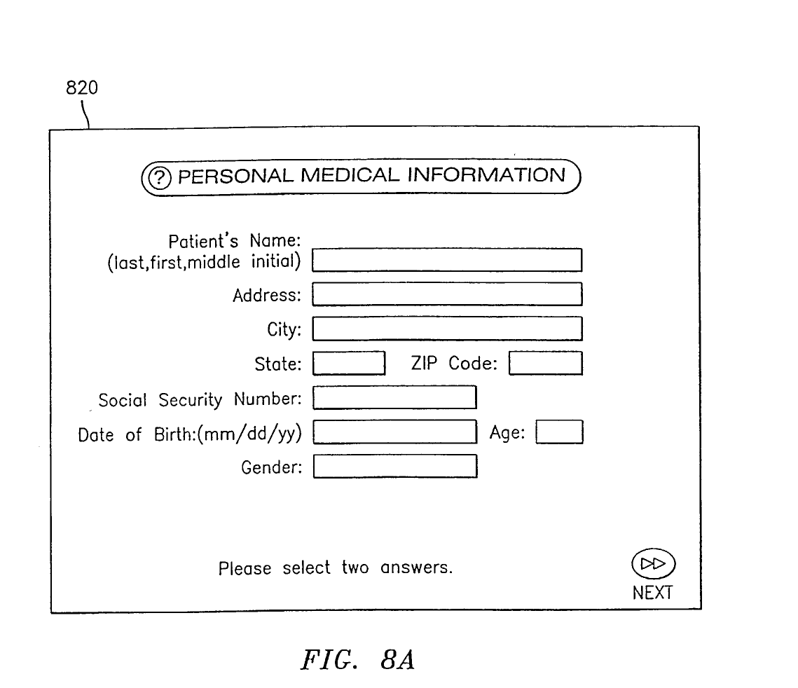

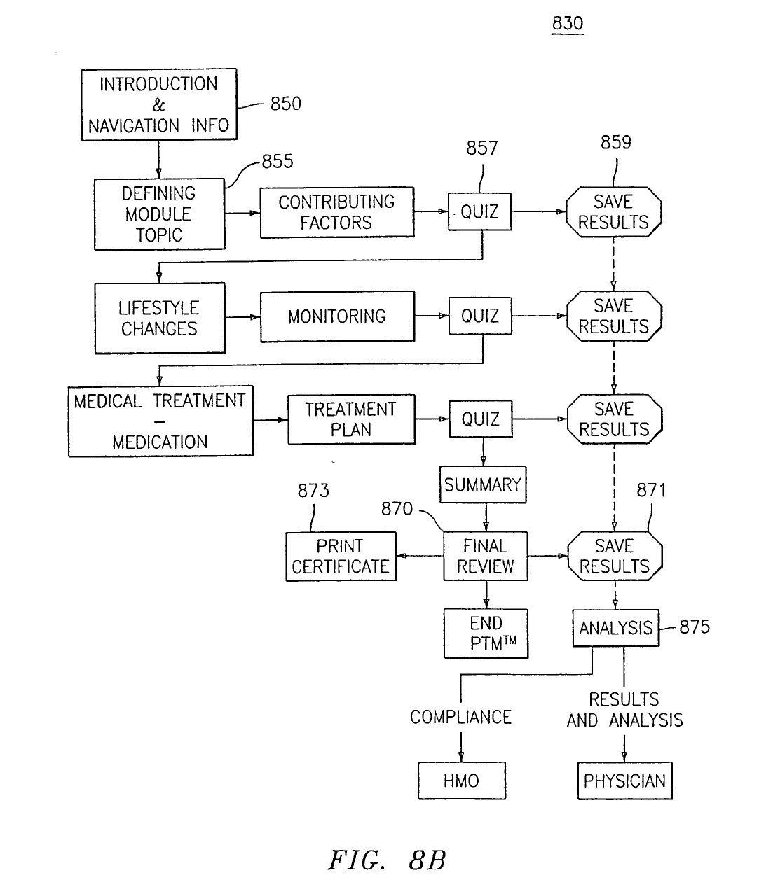

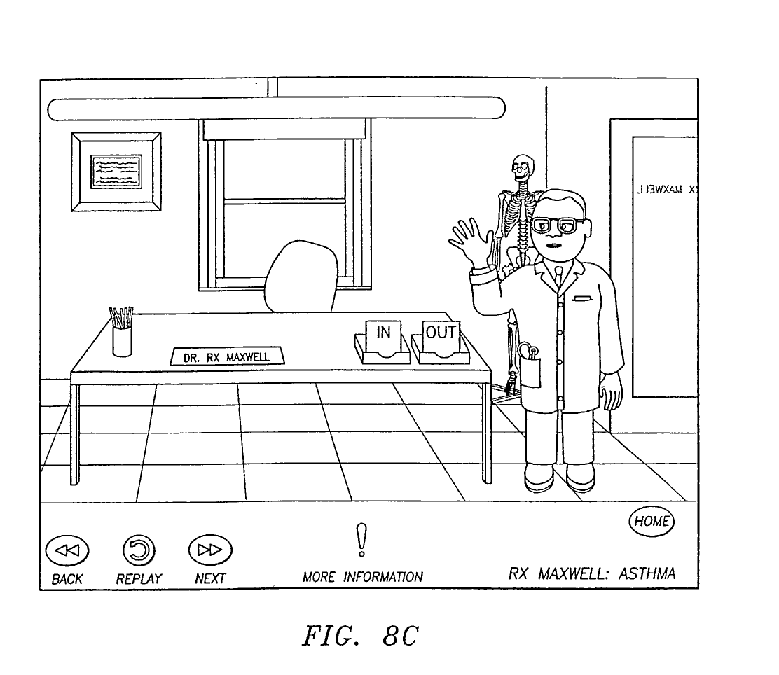

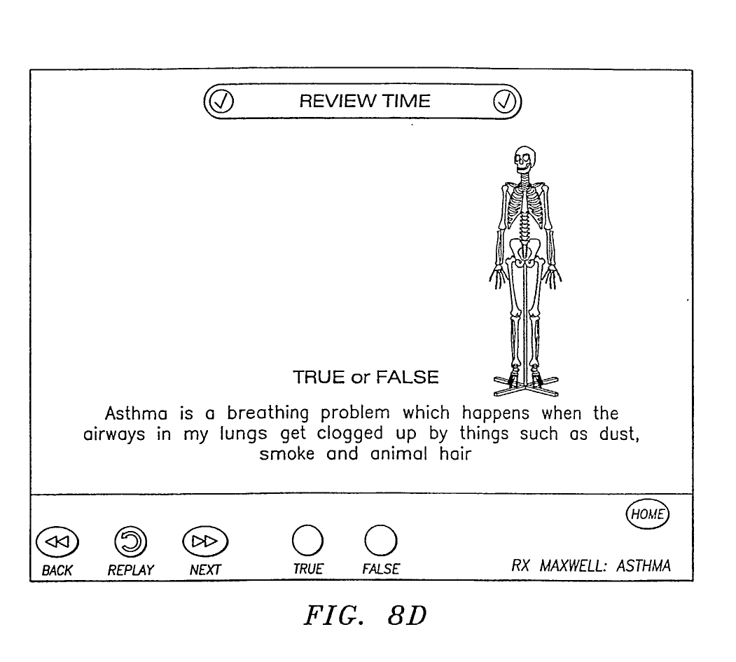

Each PTM is part of a computer sequence, as shown in FIGS. 7, 8, and 8A-8D. As shown in FIG. 7, in standby mode, the computer remains in standby mode, performing an animation sequence loop 705, until any sort of input, such as a key being pressed or a mouse click, is detected. At this point, the title animation sequence 710 is presented, after which the nurse or nurse practitioner begins the session by pressing the start button. Then the computer presents an opening index page 720, where the patient (with or without the assistance of the nurse/nurse practitioner) chooses the appropriate PTM to be taken. If the “Cancel” button is pressed, the program returns to the animation sequence loop 705.

Continuing on to FIG. 8, when the patient has selected which PTM to take, the patient presses the “Launch Module” button. The computer then requests the patient's login information 815, such as an ID, prescription number, and/or account number, before entering the questionnaire portion of the sequence. In the questionnaire portion 820, the patient answers questions about himself, which may range from identification information (name, address, Social Security number, etc.) to health and lifestyle questions. For example, if the PTM concerned tobacco use cessation, the module may ask how many cigarettes the patient presently smokes a day, how long the patient has smoked, whether the patient or any member of his family has had cancer, etc. In FIG. 8, the questionnaire 820 concerns identification material, as shown increased in size in FIG. 8A.

In this embodiment, the patient performs the questionnaire section of the sequence on the computer, but this could be done by Learning Center personnel performing pre-testing before having the patient sit down at the computer. The information gained from the questionnaire, or from a database entry corresponding to the patient's ID, is used to modify the format of the PTM. In one preferred embodiment, demographic and biographical data is also used to modify the presentation to fit the I.Q. of the patient, as well as to personalize the interaction between the PTM and the patient (calling the patient by his or her name, asking questions about the patient's children, etc.). Once the questionnaire 820 is complete, the patient moves on to the PTM 830.

Each PTM 830 is preferably constructed in multiple parts, as shown in FIG. 8B. An introduction 850 describes how to interact with the PTM. In the preferred embodiments, the introduction 850 has a sequence, of which FIG. 8C is a frame, where an animated character explains how to use the on-screen buttons (such as Back, Replay, Next, and Home), and how to interpret the on-screen icons (such as the In and Out boxes). Following the introduction 850, the PTM 830 has a section 855 generally describing the subject matter, whether a disease or condition, and its key components. This is followed by a Contributing Factors section detailing symptoms and/or triggers that adversely affect health. At the end of a portion of the PTM, a Quiz, such as 857, is given to confirm the patient's absorption of the material. The results of the Quiz are stored 859 for later analysis. In other embodiments, the Quiz may involve more than answering questions; for instance, the patient may attempt to use self-testing medical equipment that is connected to and monitored by the computer. Furthermore, such testing may be used in the questionnaire 820 section.

FIG. 8B shows three main sections, each ending with a Quiz, of which the results are stored. An exemplary frame of how such a quiz appears in an embodiment is shown in FIG. 8D. The various sections cover different aspects and facets of the subject matter, and include material such as the changes in lifestyle that the patient may undertake, monitoring, relevant medications and medical treatment, and a section on compliance or treatment plans. As indicated above, the patient or consumer is presented with several true or false questions at the end of each section (the Quiz 857) to ascertain the patient's understanding of the subject matter. At the conclusion of the PTM, the patient is given a multiple choice test (the Final Review 870) to assess the effectiveness of the learning module, and the results 871 of this test, as well as the results of the Quizzes, are forwarded for Analysis 875, which may be performed by medical personnel in the Learning Center, or by a program, or by a combination of both. The results of this Analysis 875, and/or the test results, are sent to the patient's physician for further action or treatment.

For compliance purposes, a certificate is printed 873 for the patient, upon completion of the Final Review 870. This certificate may be kept as a record of compliance. Furthermore, in the preferred embodiments, the HMO is notified of compliance after Analysis 875 is performed. It should be noted that the present invention is not limited to this sequence, and that the steps may be in a different order, and may take a different form, than as shown in the embodiment in FIG. 8B. For example, the Analysis step 875 could be removed in an embodiment in which the physician receives only the hard data results of the testing, and the physician performs her own analysis.

In the preferred embodiments, the PTMs are designed to be self-modifying in real-time, meaning the presentation sequence and format may change according to the results of each section quiz. The patient is not permitted to skip or run through the learning module. The module only allows the patient or consumer to move forward when a particular section is completed.

In the preferred embodiments, each multi-part module is narrated by an animated doctor character, as shown in FIG. 8C, who together with an animated nurse character and other animated support character will both teach and test patients to verify patient education and to document changes in patient behavior. Teaching sessions are supervised by specially trained nursing personnel, who also teach and test patients to verify patient education, as well as perform follow-up via telephone and videoconferencing. Additional learning aids may be used with the PTMs, such as models or input/output devices using other senses, such as tactile sensation.

Each module becomes an integral part of the doctor's treatment. The results of the initial sessions—and one or more follow-up sessions—provide the doctor with invaluable, currently unavailable information which enables the doctor to more precisely prescribe a course of treatment for each patient.

C. Feedback, Follow-up, and Analysis

In the preferred embodiments, the information gleaned from the patient's visit to the Learning Center will be funneled in various directions, and used to specify a course of follow-up treatment. In other embodiments, there may be less or no feedback, feedback, or analysis. For instance, in embodiments where the PTM is obtained by the consumer on a CD-ROM, the analysis may be performed by a program already stored on the CD-ROM. In this case, the program would analyze the answers and data input by the consumer and provide guidance as to further action or research. The analysis program on the CD-ROM could also print out a certificate of compliance once the PTM has been finished.

In the preferred embodiments, the results and analysis from the PTM are transferred into the patient's chart in a variety of ways: by delivery, mail, or fax for doctors without computer or Internet support, and electronically via the Internet for doctors with computer access to the Internet. This is the preferred delivery method. In the preferred embodiments, HMOs will not have direct access to the module results, but they are provided with selective information to document patient education, compliance, and trends towards outcomes. In other embodiments, HMOs may have greater access to information or no access at all. As another example, in the preferred embodiment shown in FIG. 6, the information obtained is not shared with any health insurance institution, but with school authorities and parents. Likewise, information and analyses obtained when using the present invention could be used by governmental institutions.

Additionally, the broader, macro information about how and what patients learn, and whether and to what extent such learning affects patients behavior—and outcomes—is collected and analyzed. This is extraordinarily valuable information to use, by the HMOs, the government, physicians, schools, and patient educators, generally.

Regular, personalized follow up is essential in engendering patient comfort, confidence and compliance. The patient will be encouraged to later return to the center for one or more follow-up sessions, where the patient's knowledge and understanding is further tested and evaluated. The patient is also asked to discuss his or her experience with the disease, i.e. evidence of illness, lost work, and visits to doctors or hospitals. This information provides valuable information confirming—or disproving—patient education, compliance, and beneficial outcomes. It is estimated that during the beta testing of the modules and the learning center, both the modules and the learning center environment will be evaluated and modified to maximize patient education and compliance.

Although the above embodiment uses computers, other devices could be used to present information, test knowledge, and collate data.

Although the preferred embodiments of the present invention have been disclosed for illustrative purposes, those skilled in the art will appreciate that various modifications, additions and substitutions are possible, without departing from the scope and spirit of the invention as disclosed.

What is claimed is:

1. A computer-based method for health education, comprising the steps of:
presenting, to a subject, on a display an interactive educational presentation concerning at least one of a medical treatment, condition, and medication;
testing the subject on the at least one of medical treatment, condition, and medication; and
analyzing results from the testing;
wherein the subject responds to questions and/or commands concerning the interactive educational presentation by means of at least one input/output device.

2. The computer-based method as recited in claim 1, further comprising the step of:
communicating the analysis to a physician of the subject.

3. The computer-based method as recited in claim 1, further comprising the step of:
communicating compliance information concerning the subject to an insurer of the subject.

4. The computer-based method as recited in claim 1, wherein, before the presenting step, the method further comprises the step of:
assigning, by one of a physician of the subject and an insurer of the subject, the interactive educational presentation for the subject.

5. The computer-based method as recited in claim 1, further comprising the steps of:
communicating the analysis to a physician of the subject; and
communicating compliance information concerning the subject to an insurer of the subject;
wherein said communicating steps are performed over a computer network.

6. The computer-based method as recited in claim 1, wherein the presenting step is performed by a computer.

7. The computer-based method as recited in claim 6, wherein the computer is a personal computer, and the subject interacts with the presentation using at least one of a keyboard and a mouse.

8. The computer-based method as recited in claim 1, wherein the testing step is performed by a computer.

9. The computer-based method as recited in claim 8, wherein the computer is a personal computer, and the subject responds to the testing using at least one of a keyboard and a mouse.

10. The computer-based method as recited in claim 1, wherein the analyzing step is performed by a computer.

11. The computer-based method as recited in claim 1, wherein the interactive educational presentation is stored on a CD-ROM, and played back during the presenting step.

12. The computer-based method as recited in claim 1, wherein the interactive educational presentation is adjusted in real time, during the presenting step, in response to interaction with the subject.

13. The computer-based method as recited in claim 1, further comprising the step of:
preparing a course of treatment, based on the analysis.

14. The computer-based method as recited in claim 1, further comprising the step of:
preparing additional educational material, including at least one of presentations, activities, and reading material, based on the analysis.

15. A method of educating a subject in a medical treatment, condition, or medication, comprising the steps of:
assigning, to the subject, an interactive educational presentation concerning at least one of a medical treatment, condition, and medication;
presenting, to the subject, the interactive educational presentation concerning the at least one of a medical treatment, condition, and medication;
testing the subject on the at least one of a medical treatment, condition, or medication;
analyzing results from the testing;
communicating the analysis to a physician of the subject; and
communicating compliance information concerning the subject to an insurer of the subject.

16. The method as recited in claim 15, wherein the interactive educational presentation is stored on a CD-ROM, and played back during the presenting step.

17. The method as recited in claim 15, wherein the interactive educational presentation is adjusted in real time, during the presenting step, in response to interaction with the subject.

18. The method as recited in claim 15, further comprising the step of:
preparing a course of treatment, based on the analysis.

19. The method as recited in claim 15, further comprising the step of:
preparing additional educational material, including at least one of presentations, activities, and reading material, based on the analysis.

20. A method of facilitating health education compliance by an insured party, comprising the steps of:
assigning, to the insured party, an interactive educational presentation concerning a medical treatment, condition, or medication, said assigning being performed by one of a physician of the insured party or an insurer of the insured party;
presenting, to the insured party, the interactive educational presentation concerning the medical treatment, condition, or medication;
testing the insured party on the medical treatment, condition, or medication;
analyzing results from the testing; and
communicating compliance information concerning the insured party to the insurer.

21. A computer system for health education, comprising:
means for presenting, to a subject, an interactive educational presentation concerning at least one of a medical treatment, condition, and medication;
means for testing the subject on the at least one of medical treatment, condition, and medication; and
means for analyzing results from the testing.

22. The computer system as recited in claim 21, further comprising:
means for communicating the analysis to a physician of the subject.

23. The computer system as recited in claim 21, further comprising:
means for communicating compliance information concerning the subject to an insurer of the subject.

24. The computer system as recited in claim 21, wherein one of a physician of the subject and an insurer of the subject assigns the interactive educational presentation to the subject.

25. The computer system as recited in claim 21, wherein the means for presenting comprises:
a personal computer, with at least one of a keyboard and a mouse.

26. The computer system as recited in claim 21, wherein the means for testing comprises:
a personal computer, with at least one of a keyboard and a mouse.

27. The computer system as recited in claim 21, wherein the interactive educational presentation is stored on a CD-ROM, and played back by the presenting means.

28. The computer system as recited in claim 21, wherein the interactive educational presentation is adjusted in real time, by the presenting means, in response to interaction with the subject.

29. The computer system as recited in claim 21, wherein the means for analyzing further prepares a course of treatment, based on the analysis.

30. The computer system as recited in claim 21, wherein the means for analyzing further assigns additional educational material, including presentations, activities, and reading material, based on the analysis.

31. A computer system for educating a subject in a medical treatment, condition, or medication, comprising:
means for presenting, to the subject, an interactive educational presentation concerning at least one of a medical treatment, condition, and medication, said interactive educational presentation being assigned to the subject by one of a physician of the subject and an insurer of the subject;
means for testing the subject on the at least one of medical treatment, condition, and medication;
means for analyzing results from the testing;
means for communicating the analysis to the physician of the subject; and
means for communicating compliance information concerning the subject to the insurer of the subject.

32. The computer system as recited in claim 31, wherein the interactive educational presentation is stored on a CD-ROM, and is played back by the presenting means.

33. The computer system as recited in claim 31, wherein the interactive educational presentation is adjusted in real time, by the presenting means, in response to interaction with the subject.

34. The computer system as recited in claim 31, wherein the analyzing means further assigns additional educational material, including at least one of presentations, activities, and reading material, based on the analysis.

35. A computer system for facilitating health education compliance by an insured party, comprising:
means for presenting, to the insured party, an interactive educational presentation concerning a medical treatment, condition, or medication, said interactive educational presentation being assigned to the insured party by one of a physician of the insured party or an insurer of the insured party;
means for testing the insured party on the medical treatment, condition, or medication;
means for analyzing results from the testing; and
means for communicating compliance information concerning the insured party to the insurer.
